(19) United States
(12) Patent Application Publication
(10) Pub. No.: US 2017/0372109 A1
(43) Pub. Date: Dec. 28, 2017

(54) CAPACITIVE FINGERPRINT RECOGNITION MODULE

(71) Applicant: Primax Electronics Ltd., Taipei (TW)

(72) Inventors: YONG LIU, Taipei (TW); AI-LING HE, Taipei (TW)

(21) Appl. No.: 15/591,580

(22) Filed: May 10, 2017

Related U.S. Application Data
(60) Provisional application No. 62/353,242, filed on Jun. 22, 2016.

(51) Int. Cl. G06K 9/00

(52) U.S. Cl. CPC G06K 9/0002

(57) ABSTRACT

This application provides a capacitive fingerprint recognition module, including a substrate, a fingerprint recognition chip, a mold compound, a chip adhesive layer, and a cover plate. The mold compound and the fingerprint recognition chip are disposed on the substrate, and the mold compound packages the fingerprint recognition chip. The cover plate is covered on the chip adhesive layer, so that a squeezed part of the chip adhesive layer is squeezed beyond an edge of the cover plate and is exposed outside. The chip adhesive layer is selected from a non-white material, and therefore the squeezed part of the chip adhesive layer is visually hidden. By means of the configuration, a process of clearing the squeezed part of the chip adhesive layer may be omitted.

### FIELD OF THE INVENTION

This application relates to a fingerprint recognition module, and in particular, to a capacitive fingerprint recognition module.

### BACKGROUND OF THE INVENTION

A conventional fingerprint recognition module is formed by stacking and assembling multiple elements. For example, the sequence of stacking the multiple elements from top to down is: a cover body, a mold compound, a fingerprint recognition chip, and a substrate. The mold compound packages the fingerprint recognition chip, and the mold compound and the fingerprint recognition chip are together disposed on the substrate. In addition, the cover body is adhered above the mold compound by using an adhesive. The adhesive is subjected to a pressure during assembly to be squeezed out towards a side direction, and the squeezed adhesive goes beyond an edge of the cover body and therefore is exposed outside. An adhesive applied in a conventional fingerprint recognition module is white. The white adhesive exposed outside is considered as a defect. Therefore, an extra clearing process needs to be performed on the white adhesive exposed outside for the conventional fingerprint recognition module. Therefore, complexity of manufacturing of a product and labor costs are increased. In view of the above, the conventional fingerprint recognition module still needs to be improved.

### SUMMARY OF THE INVENTION

A main objective of the present invention is to provide a capacitive fingerprint recognition module. A squeezed part of a chip adhesive layer is exposed by a gap of a cover body, and therefore by manufacturing the chip adhesive layer using a non-white material instead, the squeezed part is not exposed due to reflection of the cover body and is no longer considered as a defect, thereby further simplifying the manufacture procedure.

A preferable implementation concept of this application is to provide a capacitive fingerprint recognition module, including:

a substrate;

a fingerprint recognition chip, disposed above the substrate in an adhesive manner;

a bonding wire, where two ends of the bonding wire are electrically connected to the fingerprint recognition chip and the substrate, respectively;

a mold compound, located above the substrate and packaging the fingerprint recognition chip and the bonding wire;

a chip adhesive layer, applied on an upper surface of the mold compound, where the material of the chip adhesive layer is selected from a non-white material; and a cover plate, covered on the chip adhesive layer and adhered above the mold compound by using the chip adhesive layer.

In a preferred embodiment, the material of the chip adhesive layer is selected from a black material or a transparent material.

In a preferred embodiment, the capacitive fingerprint recognition module further includes a thin film circuit board and a first adhesive layer, where the thin film circuit board is disposed below the substrate, and the first adhesive layer is disposed between the substrate and the thin film circuit board, so as to adhere the substrate to the thin film circuit board.

In a preferred embodiment, the capacitive fingerprint recognition module further includes a metal support plate and a second adhesive layer, where the metal support plate is disposed below the thin film circuit board, and the second adhesive layer is disposed between the thin film circuit board and the metal support plate, so as to adhere the thin film circuit board to the metal support plate.

In a preferred embodiment, the capacitive fingerprint recognition module further includes a frame body, where the frame body is disposed on the thin film circuit board, and the frame body encircles the substrate, the fingerprint recognition chip, the mold compound, the chip adhesive layer, and the cover plate.

In a preferred embodiment, a gap is provided between the frame body and the cover plate, the chip adhesive layer is squeezed by the cover plate and the mold compound to form a squeezed part, and the squeezed part is located below the gap.

### BRIEF DESCRIPTION OF THE DRAWINGS

FIG. 1 is a schematic stereoscopic exploded diagram of a capacitive fingerprint recognition module of this application; and

FIG. 2 is a schematic sectional diagram of a capacitive fingerprint recognition module of this application.

### DETAILED DESCRIPTION OF THE PREFERRED EMBODIMENT

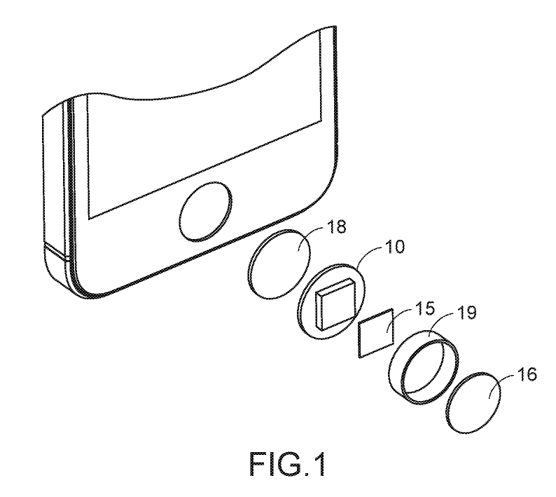

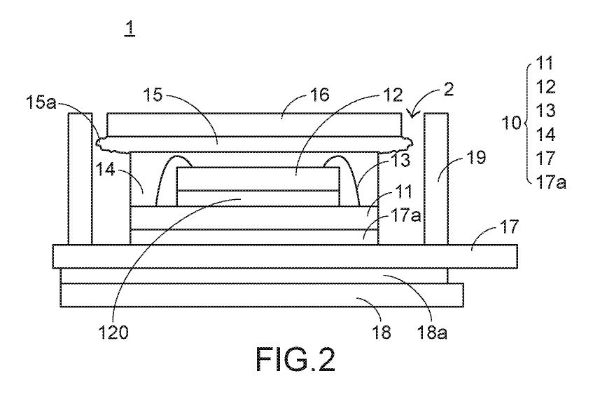

FIG. 1 is a schematic stereoscopic exploded diagram of a capacitive fingerprint recognition module of this application; and FIG. 2 is a schematic sectional diagram of a capacitive fingerprint recognition module of this application. As shown in FIG. 1 and FIG. 2, a capacitive fingerprint recognition module 1 of this application includes a substrate 11, a fingerprint recognition chip 12, a bonding wire 13, a mold compound 14, a chip adhesive layer 15, a cover plate 16, and a frame body 19. A fingerprint recognition chip 12 is disposed above the substrate 11, and the fingerprint recognition chip 12 is adhered to the substrate 11 by using an adhesive 120. A manner of electrically connecting the fingerprint recognition chip 12 and the substrate 11 is that the fingerprint recognition chip 12 is electrically connected to the substrate 11 by using the bonding wire 13, so that the fingerprint recognition chip 12 transmits a generated sensing signal to the substrate 11 by means of the bonding wire 13. In addition, the mold compound 14 is also located above the substrate 11, encircles, packages, and fastens the fingerprint recognition chip 12 and the bonding wire 13, and has a function of protecting the fingerprint recognition chip 12 and the bonding wire 13 that are in the mold compound 14.

Further, a chip adhesive layer 15 is applied on an upper surface of the mold compound 14. The cover plate 16 is covered on the chip adhesive layer 15, that is, the cover plate 16 is adhered above mold compound 14 by using the chip adhesive layer 15. It should be particularly noted herein that the cover plate 16 may be ceramic material layer or a glass material layer with a colored bottom surface. That is, hardness of the cover plate 16 is improved to prevent the cover plate 16 from being abrased or scratched. Secondly, the frame body 19 is preferably ring-shaped and encircles the substrate 11, the fingerprint recognition chip 12, the mold compound 14, the chip adhesive layer 15, and the cover plate 16 in space defined by encircling. However, as shown in FIG. 2, a gap 2 still exists between the frame body 19 and the cover plate 16, and when the cover plate 16 is stacked above the mold compound 14 and the chip adhesive layer 15, the chip adhesive layer 15 is directly subjected to a pressure from the cover plate 16 and is squeezed beyond an edge of the cover plate towards a side direction. This behavior is referred to as adhesive overflow and is a scenario that is difficult to avoid during assembly. A squeezed part 15a that is squeezed out is exposed outside at the gap 2.

Moreover, because the cover plate 16 uses a ceramic or glass material, the reflective rate of the cover plate 16 is relatively high. To avoid highlighting, by light rays reflected by the cover plate 16, of the squeezed part 15a of the chip adhesive layer 15 that is exposed between the cover plate 16 and the frame body 19, in a preferred implementation aspect of this application, the material of the chip adhesive layer 15 is selected from a black material or a transparent material, to lower the rate of light rays reflected by the chip adhesive layer 15, that is, discovery of the squeezed part 15a by a user is avoided. In another preferred implementation aspect, the color of the material of the chip adhesive layer 15 is the same as or is close to that of the cover plate 16 or the frame body 19. In this way, the squeezed part 15a is not discovered by the user, either. In the foregoing two implementation aspects, although the squeezed part 15a of the chip adhesive layer 15 that is squeezed out still protrudes from the gap 2 which is defined between the cover plate 16 and the frame body 19, it cannot be seen by human eyes because the gap 2 is small and a reflective rate of light rays of the chip adhesive layer 15 is lowered. Therefore, the squeezed part 15a is not regarded as a defect. Therefore, an extra clearing process does not need to be performed on an adhesive part (the squeezed part 15a) exposed outside for the fingerprint recognition module of this application, thereby reducing manufacturing complexity of the whole fingerprint recognition module and labor costs.

The capacitive fingerprint recognition module of this application further includes a thin film circuit board 17 and a first adhesive layer 17a. The thin film circuit board 17 is disposed below the substrate 11. The first adhesive layer 17a is disposed between the substrate 11 and the thin film circuit board 17, so as to adhere the above substrate 11 to the below thin film circuit board 17. The substrate 11 may be mutually electrically connected to the thin film circuit board 17, and a circuit connection manner between the two may be electric connection by using a conductive pin (not shown) or in other manners, which are well known to a person in the art, and therefore details are not provided herein.

It should be particularly noted herein that the substrate 11, the fingerprint recognition chip 12, the bonding wire 13, the mold compound 14, the thin film circuit board 17, and the first adhesive layer 17a may be implemented in a manner of a land grid array (Land grid array, LGA) 10.

In addition, the capacitive fingerprint recognition module of this application further includes a metal support plate 18 and a second adhesive layer 18a. The metal support plate 18 is disposed below the thin film circuit board 17, and the second adhesive layer 18a is disposed between the thin film circuit board 17 and the metal support plate 18, so as to adhere the above thin film circuit board 17 to the below metal support plate 18.

In conclusion, in the capacitive fingerprint recognition module of this application, the chip adhesive layer is made of a non-white material instead, so as to lower the light ray reflectivity of the chip adhesive layer, thereby hiding the squeezed part of the chip adhesive layer. In this way, a process of clearing the squeezed part of the chip adhesive layer may be omitted, that is, manufacturing complexity of a whole product and labor costs may be lowered.

The foregoing embodiments only exemplarily describe the principle and effects of the prevent invention and state the technical features of the present invention, and are not intended to limit the protection scope of the present invention. Change or equivalent arrangement that can be easily accomplished by a person skilled in the art without violating the technical principle and spirit of the present invention belongs to the scope claimed in the present invention. Therefore, the claims of the present invention should be as listed in the following claims.

What is claimed is:

1. A capacitive fingerprint recognition module, comprising:
a substrate;
a fingerprint recognition chip, disposed above the substrate in an adhesive manner;
a bonding wire, wherein two ends of the bonding wire are electrically connected to the fingerprint recognition chip and the substrate, respectively;
a mold compound, located above the substrate and packaging the fingerprint recognition chip and the bonding wire;
a chip adhesive layer, applied on an upper surface of the mold compound, wherein the material of the chip adhesive layer is selected from a non-white material; and
a cover plate, covered on the chip adhesive layer and adhered above the mold compound by using the chip adhesive layer.

2. The capacitive fingerprint recognition module according to claim 1, wherein the material of the chip adhesive layer is selected from a black material or a transparent material.

3. The capacitive fingerprint recognition module according to claim 2, further comprising a thin film circuit board and a first adhesive layer, wherein the thin film circuit board is disposed below the substrate, and the first adhesive layer is disposed between the substrate and the thin film circuit board, so as to adhere the substrate to the thin film circuit board.

4. The capacitive fingerprint recognition module according to claim 3, further comprising a metal support plate and a second adhesive layer, wherein the metal support plate is disposed below the thin film circuit board, and the second adhesive layer is disposed between the thin film circuit board and the metal support plate, so as to adhere the thin film circuit board to the metal support plate.

5. The capacitive fingerprint recognition module according to claim 3, further comprising a frame body, wherein the frame body is disposed on the thin film circuit board, and the frame body encircles the substrate, the fingerprint recognition chip, the mold compound, the chip adhesive layer, and the cover plate.

6. The capacitive fingerprint recognition module according to claim 5, wherein a gap is provided between the frame body and the cover plate, the chip adhesive layer is squeezed by the cover plate and the mold compound to form a squeezed part, and the squeezed part is located below the gap.
